(19) United States
(12) Patent Application Publication
(10) Pub. No.: US 2006/0031654 A1
(43) Pub. Date: Feb. 9, 2006

(54) Boot methods and systems

(75) Inventor: Ivan Liang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/037,736

(22) Filed: Jan. 18, 2005

(30) Foreign Application Priority Data
Aug. 4, 2004 (TW) 93123340

(51) Int. Cl. G06F 12/16

(52) U.S. Cl. 711/170

(57) ABSTRACT

Boot methods and systems. When an electronic device boots, it is determined whether a boot device corresponding to the electronic device is detected. If no boot device is detected, detection of the boot device is repeated until the boot device is detected. Once the boot device is detected, an operating system is loaded on the electronic device, thereby completing a boot procedure of the electronic device.

### BACKGROUND

The invention relates to boot management, and particularly to boot methods and systems that actively and continuously detect a boot device for automatically booting a processor-based device.

Processor-based devices, such as computer systems are widely used by enterprises and individuals. Most computer systems utilize a data storage device, such as a hard disk, as a boot device. To further protect the security of devices and maintain access right thereto, some devices can employ external devices, such as a PC card or a memory card for device booting.

FIG. 1 is a flowchart showing a conventional boot method of an electronic device. After the electronic device is powered on, in step S110, an OS (Operating System) loader inside the electronic device first detects a boot device designated by the electronic device. If the boot device is detected (Yes in step S120), in step S130, the OS loader continues to load an operating system, thereby completing a boot procedure of the electronic device. If no boot device is detected (No in step S120), the procedure is complete, and the electronic device enters a halt state. At this time, the boot procedure for the electronic device cannot be performed automatically, and requires user intervention. After a boot device is plugged into the electronic device, a specific key must be pressed to direct the electronic device to redetect the boot device for completing the entire boot procedure.

As described above, if no boot device is detected, the conventional method has no mechanism for automatically handling the situation and completing the entire boot procedure. In some cases, the electronic device must be restarted, thereby increasing the complexity, and delaying the boot procedure.

### SUMMARY

Boot methods are provided. In an exemplary embodiment of a boot method, when an electronic device boots, it is determined whether a boot device corresponding to the electronic device is detected. If no boot device is detected, the detection is repeated until the boot device is detected. Once the boot device is detected, an operating system is loaded on the electronic device, thereby completing a boot procedure.

An initiation procedure is further performed for hardware of the electronic device, and the boot device is initiated if the boot device is detected.

Some embodiments of detection method for the boot device check for a flag status corresponding to the boot device in the electronic device. When the boot device couples to the electronic device, the flag status is dynamically set as a direction indicating the boot device exists.

The boot device is a PnP (Plug and Play) device, a USB (Universal Serial Bus) device, or a memory card.

Boot systems are further provided. An exemplary system comprises a connection device and an OS loader. The connection device can be coupled with a boot device. When the system is booted, the OS loader determines whether the boot device is coupled to the connection device. If the boot device is not detected on the connection device, the detection is repeated until the boot device is detected. Once the boot device is detected, the OS loader continues to load an operating system, thereby completing a boot procedure.

The OS loader further performs an initiation procedure for system hardware, and initiates the boot device if the boot device is detected.

The OS loader detects the boot device by checking a flag status corresponding to the boot device in the system. When the boot device couples to the connection device, the flag status is dynamically set as a direction indicating the boot device exists.

The boot device is a PnP device, a USB device, or a memory card.

The above-mentioned embodiments of methods and systems may take the form of program code embodied in a tangible media. When the program code is loaded into and executed by a machine, the machine can become an apparatus for practicing the disclosed methods.

### DESCRIPTION OF THE DRAWINGS

Boot methods and systems will become more fully understood by referring to the following detailed description with reference to the accompanying drawings, wherein:

FIG. 1 is a flowchart showing a conventional boot method of an electronic device;

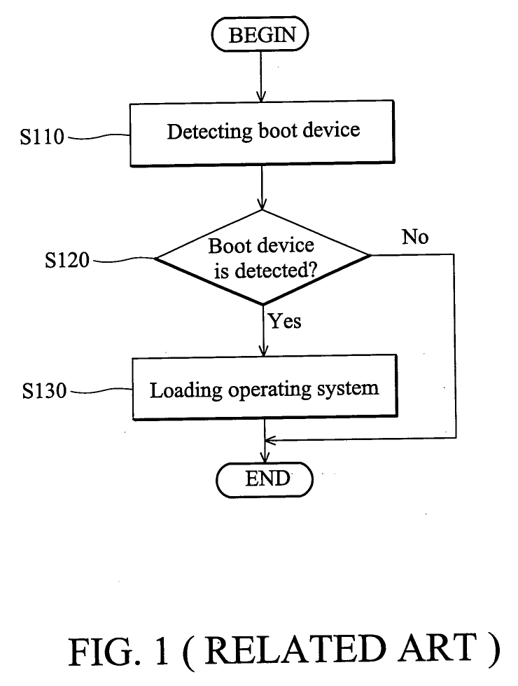

FIG. 2 is a schematic diagram illustrating the architecture of an embodiment of a boot system;

FIG. 3 is a flowchart showing an embodiment of a boot method; and

FIG. 4 is a schematic diagram illustrating a storage medium storing a computer program for execution of an embodiment of a boot method.

### DESCRIPTION

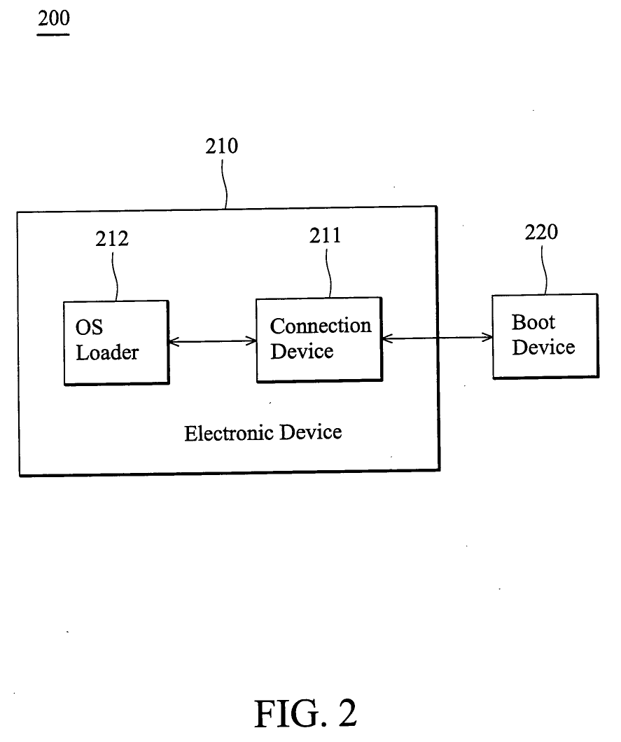

FIG. 2 is a schematic diagram illustrating the architecture of an embodiment of a boot system.

The system 200 includes an electronic device 210 and a boot device 220. The electronic device 210 may be a processor-based device, comprising at least a connection device 211 and an OS loader 212. The connection device 211 can be coupled with the boot device 220. The connection device 211 can comprise various interfaces, such as USB (Universal Serial Bus), PCI (Peripheral Component Interconnect), and PCMCIA (Personal Computer Memory Card International Association) interfaces. The boot device 220 may be a PnP device, a USB device, or a memory card, such as a PCMCIA or PC card. The OS loader 212 controls a boot procedure of the electronic device 210, and loads an operating system, thereby completing the boot procedure of the electronic device 210.

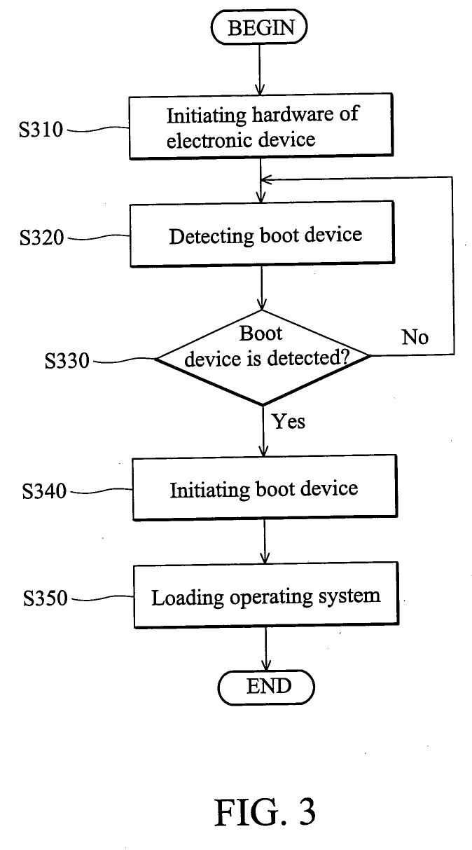

FIG. 3 is a flowchart showing an embodiment of a boot method.

When the electronic device 210 is powered on, in step S310, the OS loader 212 first performs an initiation procedure for necessary hardware, such as memory, slots, and others of the electronic device 210. Then, in step S320, the OS loader 212 detects whether the boot device 220 designated by the electronic device 210 exists. That is, the OS loader 212 determines whether the boot device 220 is already coupled to the connection device 211 of the electronic device 210. In some embodiments, the OS loader 212 detects the boot device 220 by checking a flag status corresponding to the boot device 220 in the electronic device 210. When the boot device 220 couples to the connection device 211, the flag status is dynamically set in an electric or mechanical manner as a direction indicating the boot device 220 exists.

If the boot device 220 is detected (Yes in step S330), in step S340, the OS loader 212 initiates the boot device 220, and in step S350, continues to load an operating system, thereby completing the boot procedure of the electronic device 210. If the boot device 220 is not detected on the connection device 211, the process returns to step S320, the OS loader 212 repeats the detection until the boot device 220 is detected. If the electronic device is powered on and no boot device is coupled thereto, the electronic device does not require restarting, and the boot procedure can be automatically completed without any user intervention.

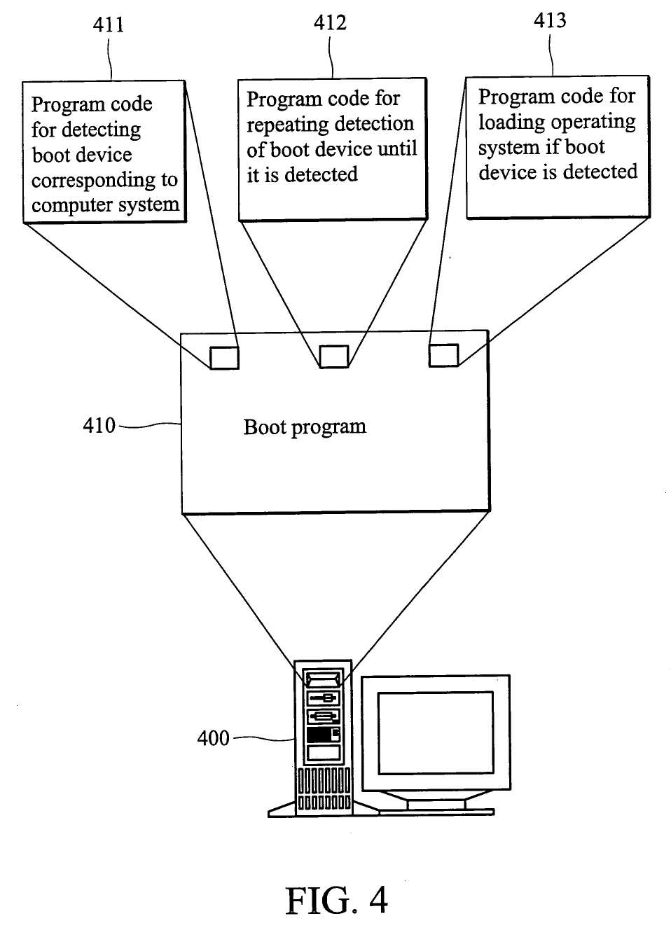

FIG. 4 is a diagram of a storage medium storing a computer program providing an embodiment of a boot method. The computer program product comprises a storage medium 410 having computer readable program code embodied therein for use in a computer system 400. The computer readable program code comprises at least computer readable program code 411 detecting a boot device corresponding to the computer system, computer readable program code 412 repeating detection of the boot device until it is detected if no boot device is detected, and computer readable program code 413 continuing to load an operating system to the computer system if the boot device is detected, thereby completing a boot procedure of the computer system.

Boot methods and systems actively and continuously detect a boot device for automatically booting an electronic device, thus potentially reducing the boot complexity of the electronic device, and improving the flexibility and convenience of the boot procedure.

Boot systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the embodiment. The method and system may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed embodiment. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A boot method for use in a processor-based electronic device, comprising:
when the electronic device boots,
detecting a boot device corresponding to the electronic device;
determining whether the boot device is detected;
repeating the detection of the boot device until the boot device is detected if no boot device is detected; and
continuously loading an operating system on the electronic device if the boot device is detected, thereby completing a boot procedure of the electronic device.

2. The method of claim 1 further comprising performing a procedure for initiating hardware of the electronic device.

3. The method of claim 1 further comprising initiating the boot device if the boot device is detected.

4. The method of claim 1 further comprising detecting the boot device by checking a flag status corresponding to the boot device in the electronic device, in which the flag status is dynamically set as a direction indicating the boot device exists when the boot device couples to the electronic device.

5. The method of claim 1 wherein the boot device comprises a PnP (Plug and Play) device, a USB (Universal Serial Bus) device, or a memory card.

6. A boot system, comprising:
a connection device for coupling with a boot device; and
an OS (Operating System) loader to detect the boot device when the system boots, determining whether the boot device is detected, repeating the detection of the boot device until the boot device is detected if no boot device is detected, and continuously loading an operating system if the boot device is detected, thereby completing a boot procedure of the system.

7. The system of claim 6 wherein the OS loader further performs a procedure for initiating hardware of the system.

8. The system of claim 6 wherein the OS loader further initiates the boot device if the boot device is detected.

9. The system of claim 6 wherein the OS loader detects the boot device by checking a flag status corresponding to the boot device in the system, in which the flag status is dynamically set as a direction indicating the boot device exists when the boot device couples to the connection device.

10. The system of claim 6 wherein the boot device comprises a PnP (Plug and Play) device, a USB (Universal Serial Bus) device, or a memory card.

11. A machine-readable storage medium storing a computer program, causing when executed a computer to perform a boot method, the method comprising:
when the electronic device boots,
detecting a boot device corresponding to the electronic device;
determining whether the boot device is detected;
repeating the detection of the boot device until the boot device is detected if no boot device is detected; and
continuously loading an operating system on the electronic device if the boot device is detected, thereby completing a boot procedure of the electronic device.

12. The storage medium of claim 11, wherein the method further comprising performing a procedure for initiating hardware of the computer.

13. The storage medium of claim 11, wherein the method further comprising initiating the boot device if the boot device is detected.

14. The storage medium of claim 11, wherein the method further comprising detecting the boot device by checking a flag status corresponding to the boot device in the computer, in which the flag status is dynamically set as a direction indicating the boot device exists when the boot device couples to the computer.

15. The storage medium of claim 11, wherein the boot device comprises a PnP (Plug and Play) device, a USB (Universal Serial Bus) device, or a memory card.
